(19) United States
(12) Patent Application Publication
(10) Pub. No.: US 2007/0127018 A1
(43) Pub. Date: Jun. 7, 2007

(54) Inspection machine

(75) Inventors: Peter Lindner, Furth Im Wald (DE); Walter Poppel, Hagelstadt (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: KRONES AG, Neutraubling (DE)

(21) Appl. No.: 11/607,295

(22) Filed: Nov. 30, 2006

(30) Foreign Application Priority Data
Dec. 2, 2005 (DE) 10 2005 057 872.1

(51) Int. Cl. G01N 21/00

(52) U.S. Cl. 356/240.1

(57) ABSTRACT

An inspection machine (M) for checking particularly bottles (F) comprises a conveyor (T) for transporting the bottles along an arched path (2) and past at least one inspection device (A1-A4) associated with the arched path, and at least one illumination device (3) which is arranged below the arched path and shines light through the bottles from below and upward. The conveyor (T) presents a disk (1) which can be driven in rotation, and whose top side (9) presents a standing surface for the bottom (15) of each bottle to be transported, which stands directly on the surface, where the disk (1) is constructed so that it is transparent at least in some area.

### CROSS-REFERENCE TO RELATED APPLICATION

The present application claims the benefit of priority of German Patent Application No. 10 2005 057 872.1 filed on Dec. 2, 2005. The entire text of the priority application is incorporated herein by reference in its entirety.

### FIELD OF THE DISCLOSURE

The disclosure relates to an inspection machine used in beverage bottling production operations.

### BACKGROUND OF THE DISCLOSURE

The inspection machine known from EP 0 894 544 A presents, as conveyor, a star wheel whose circumference is fitted with clamp grippers. Each clamp gripper grips a container at approximately half its height from two sides and transports the container along the arched path past an inspection device. The clamp grippers transport the containers without bottom contact. In a bottom inspection device associated with the arched path, a stationary protection or scattering disk is arranged in a stationary manner at an interval below the bottom of the container which moves above it, with an illumination device shining light through the disk. The mechanical force which is required to clamp the containers, particularly bottles, and transport them without bottom contact, through the inspection machine, is exceedingly high. Furthermore, if necessary, the mounting of the clamp grippers has to be retrofitted for other bottle sizes. For the clamp grippers, controls are provided at the star wheel, further increasing the cost of construction.

In the bottle inspection machine known from DE 29 04 126 A, the conveyor comprises a star wheel which grips each bottle at the bottle neck and in addition at a lower place in the area of the lateral wall. Furthermore, guide arcs having different heights are provided for the bottles. Each bottle is transported without bottom contact, above a protection or scattering disk made of glass, through which the illumination device shines light from below. The disk can be rotated for cleaning in a cleaning station, either periodically or as needed. The mechanical force for transporting and positioning the bottles is high. When resetting for other bottle sizes, retrofitting work is required which is time and labor intensive.

In the inspection machine known from DE 297 07 734 U, the transporter presents a disk which can be driven in rotation and presents suction holes, in whose area the containers which are formed in the shape of cans are fixed as a result of a low-pressure application. In each case, the illumination device is accommodated in the housing of a camera of an inspection device, above the disk. The inspection covers the interior, the crimped margin, and the lateral wall of each can.

The inspection machine known from DE 196 24 552 A is arranged between feed and removal conveyors, which are oriented at an angle of approximately 90° with respect to each other, where the conveyor presents, at least along the arched path, belt drives on the interior and the exterior. Each bottle is clamped from two sides in the lateral wall area and transported in a device without bottom contact. In a bottom inspection device, a camera is provided above the bottle mouth, while a stationary illumination device is arranged in a stationary manner below the arched path and directed towards the camera. The mechanical force for transporting the bottles is high. Resetting for another bottle size requires retrofitting work which is time and labor intensive.

### SUMMARY OF THE DISCLOSURE

The disclosure is based on the problem of providing an inspection machine which has a simple construction and is cost effective, while being functionally reliable.

Because the bottles are transported as they stand on the disk of the conveyor, along the arched path and past the inspection device, of which there is at least one, there is no need for mechanically expensive transport devices, and different container sizes and configurations can be processed in the inspection machine without, or with only negligible, retrofitting work. Because the disk is designed so that it is transparent in at least some areas, the containers, in the inspection device of which there is at least one, are illuminated from below through the disk in such a manner that the inspection can be carried out with high reliability. The containers do not have to be held during the transport, and the transport does not need to take place in a device without bottom contact, which considerably simplifies the mechanical construction effort required for the inspection machine, so that a reliable but cost effective inspection machine is provided. The disk can be driven at a greater speed than a feed conveyor, so that the containers are separated from each other solely by the frictional contact with the upper side of the disk for the inspection(s).

It is advantageous for the transport of the containers to occur not only by means of the disk which can be driven in rotation; in addition to the disk, a star wheel which can be driven in rotation is provided. The construction of the star wheel is simple, because it needs only to have an entrainment effect on the container standing on the disk, without performing a height-wise positioning.

It is particularly advantageous to use a pressure decreasing star as the star wheel in an embodiment. The pressure decreasing star separates the containers, which may be conveyed standing against each other, from each other, at least along the arched path, to assist in the inspection and to ensure a high-quality inspection result.

The external diameter of the disk is advantageously greater than the effective external diameter of the star wheel. In this manner, an arched path for the containers is created which, from the beginning on, has a relatively wide dimension in the radial direction of the disk, and which makes it possible to process different container sizes or shapes without, or with only negligible, retrofitting work. At most, the associated inspection device may under some circumstances have to be radially readjusted, for example, in the case where it must be aligned with the center or the axis of the container.

In an advantageous embodiment, the feed conveyor and a removal conveyor are offset by approximately 180° with respect to each other, so that a 180° arched path is created, along which several inspections of different type can be carried out optionally.

In an advantageous embodiment, the disk, or the transparent area of the disk, is made of glass and/or a plastic, such as, PE (polyethylene). Here the material used can be clear (transparent) or light scattering (semitransparent), where it is advantageous to provide for the possibility of equipping the top side of the disk or of the transparent area of the disk in such a manner that it is very resistant against abrasion or even wear-proof (surface coating or renewable protective film).

In an advantageous embodiment, the conveyor is driven in rotation either continuously or intermittently. In the case of continuous transport, the inspection device in question is triggered precisely when the container is in the correct position for the inspection. During intermittent operation, the container stops with exact positioning in front of the inspection device, which allows more time for the inspection.

In an advantageous embodiment, an inspection device consists of a bottom inspection device which uses illumination from below and inspects the quality (absence of defects) and/or cleanliness of the bottom of the container, for example, a bottle. For this purpose, a camera is used, which is placed above the container end.

In another advantageous embodiment, a device for inspecting the interior of the container and/or a device for inspecting a threading and/or an alkaline solution detector and/or a device for inspecting the mouth sealing surfaces and/or a device for inspecting the carrier ring are integrated in the inspection machine. In this manner, several inspections can be carried out on each container, successfully or partially simultaneously, the overall results of the inspections is evaluated, and, consequently, it is possible to provide the capacity for successfully sorting out any containers that have been found to be defective or soiled upon inspection. In another embodiment, it is also possible to provide optionally, in addition to the illumination device which illuminates the disk from below, other illumination devices above the disk, to be able to further improve the inspection events.

In an advantageous embodiment, at least along the arched path, an external guide for the container is provided, so that, in spite of relatively high transport speeds, the containers cannot drift or tip over. Optionally, when resetting to a container size and/or shape, the external guide can be readjusted or replaced. However, in principle, the external guide can be designed and arranged in such a manner that it allows the processing of different container sizes and/or shapes without retrofitting.

According to another, important concept, the containers are shifted and/or rotated with respect to the disk by means of the conveyor. The transparent material of the disk is advantageously chosen in such a manner that it is not subject to detectable wear resulting from these relative movements. Thus, for example, a disk which is entirely or partially made of PE has been shown to be very advantageous and not to undergo any noteworthy wear, even after a longer lasting transport of empty bottles made of glass or PET. This resistance to wear, which ensures an even illumination of the containers, would even make it possible to drive only the star wheel at the actual transport speed, to push the containers on the top side of the stationary, or slowly running, disk along the arched path, and optionally to rotate them.

Even if the disk runs circumferentially in synchronicity with the star wheel, such relative movements occur between the containers and the disk, if the containers must be rotated intentionally for inspection purposes, and also, or at least, at the time of the transfer from the feed conveyor and the delivery to the removal conveyor. These relative movements occur necessarily due to the simplicity of the conveyor, but, because of the wear resistance of the disk, they have no negative influence on the inspection result in the long run.

In a preferred embodiment, the containers are transported with some separation between them along the arched path, to allow an inspection to be carried out, in which direct contact between the containers would interfere, for example, an inspection of the lateral wall.

In an additional embodiment, a station for multiple wall inspections is provided, at least in the area of the removal conveyor. This station makes use of the separation between the containers that has been produced by the conveyor on the disk, to inspect the containers individually, and optionally repeatedly, in the area of the lateral wall from different directions over the circumference, for example, using a kind of mirror cabinet.

To be able to sort out containers that have been identified as defective and/or soiled during the inspection, a station for sorting out is provided, preferably in the area of the removal conveyor.

The inspection machine can be used without restriction in all the conveyance situations that occur in practice; however, it is particularly preferred for moderate conveyor outputs of up to 8000 containers/hour. Here the containers should be bottles made of glass or plastic, and they should be inspected as empty containers. In that case, a long useful life of the disk is guaranteed, with substantially unchanged optical properties. Moreover, the disk or the transparent area of the disk could be associated at an appropriate position of the machine with a cleaning device, to carry out cleaning processes, either periodically or as needed. The disk would not have to be stopped for this purpose.

### BRIEF DESCRIPTION OF THE DRAWINGS

An embodiment of the object of the disclosure is explained with reference to the drawings. In the drawings:

FIG. 1 is a schematic top view of an inspection machine, and

FIG. 2 is a lateral view, for example, in the plane II-II in FIG. 1.

### DETAILED DESCRIPTION OF THE DISCLOSURE

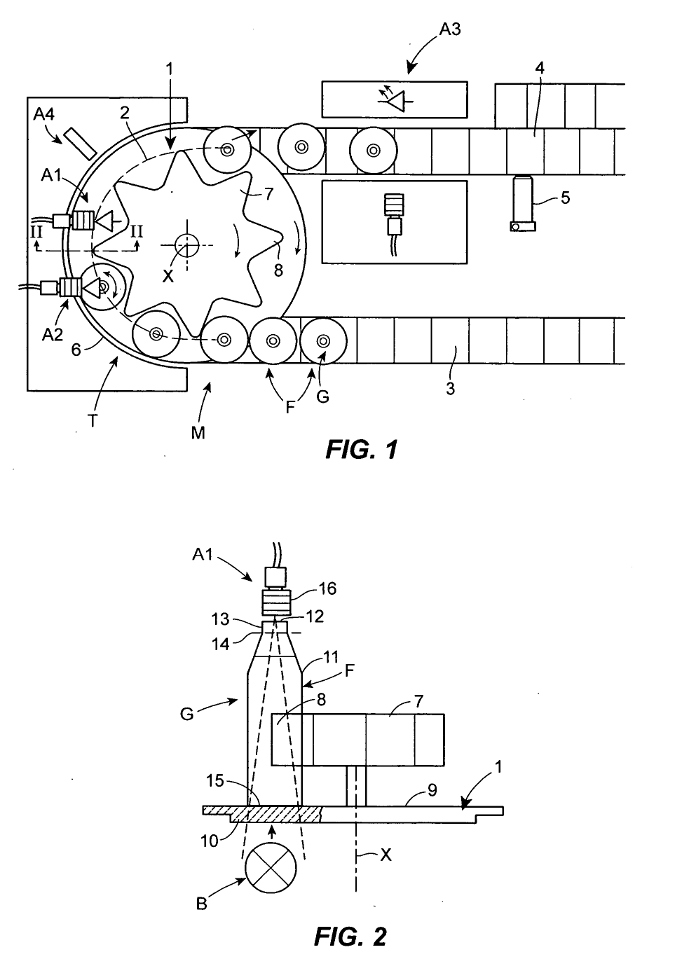

An inspection machine M, shown in a schematic top view in FIG. 1, and intended for inspecting containers G, particularly bottles F, made, for example, of glass or plastic (PET), for example, to detect damages and/or soiling, comprises a conveyor T, by means of which the containers G are conveyed continuously or intermittently in a half circle covering approximately 180°, and inspected in the process. The conveyor T, in a simple embodiment of the inspection machine M (not shown), presents only one, substantially circular, disk 1, which is driven in rotation about an axis X, and on whose top side 9 (FIG. 2), the containers G, which are standing and separated from each other, are conveyed along an arched path 2 past at least one inspection device A1, A2, A4 placed above the disk, and inspected in the process. The containers are entrained using the force of gravity and frictional forces by the disk 1, and in the process separated from each other. The containers are transferred with a feed conveyor 3, for example, in a position where they stand against each other, to the disk 1, and from the latter they are transferred, after having moved through the arched path 2, to a conveyor 4, which removes the containers G which at first are in the position in which they are separated from each other by the disk 1. The disk 1 is attached with horizontal orientation. At least along the arched path 2, an external guide 6 is provided, which is positioned, for example, at the edge of the disk 1, or which may optionally (not shown) overlap with the margin of the disk 1.

The disk consists in its entirety, or at least in an area which is associated with the arched path 2, of a transparent material. Below the disk 1, an illumination device B is provided (for example, stationary), which shines light from below upward through the disk 1 of each container G, so that the associated inspection device can carry out the inspection with the help of the illumination. The disk 1, or the transparent area 10 (FIG. 2), is made of glass and/or a plastic which is adjusted to be transparent, such as PE. The disk 1 is driven in rotation from below or from above, and from inside or from outside, about the axis X, for example, by a motor whose rpm can be regulated.

As mentioned, the containers G are, for example, bottles F made of glass or plastic (PET), and they present in each case a lateral wall 11, a mouth 12, optionally a threading 13, and optionally a holding ring 14. The bottles F stand with their bottom 15 directly on the top side 9 of the disk 1, eccentrically with respect to their axis X. If filled bottles are to be inspected, a closure may optionally be already applied to the mouth 12.

The inspection device A1 shown in FIG. 1 (and FIG. 2) is a bottom inspection device which inspects the bottom 15 through which light shines, using a digital (CCD) camera positioned above the mouth 12. In the direction of movement along the arched path 2, an additional inspection device A2 can be used to inspect the lateral wall or internal wall, the shoulder surface, or the mouth sealing surface. These inspection devices may be present only optionally, or such inspection tasks can, under some circumstances, be also carried out in connection with A1. An inspection device A4, placed behind the inspection device A1 in the direction of transport can optionally be a so-called alkaline solution detector, which responds to the presence of a quantity of alkaline solution originating from a preceding cleaning process. Furthermore, in the embodiment shown, possibly as an option, an additional inspection station A3 is provided in the area of the removal conveyor 4, which carries out multiple inspections of the lateral wall, for example, with the help of a camera and if necessary a kind of mirror cabinet.

In the embodiment of the inspection machine M, shown in FIGS. 1 and 2, as an additional part of the conveyor T, a star wheel 7 is provided, which is coaxial with respect to the axis X and driven in rotation advantageously synchronously with the disk 1, and which assists in the positioning of the containers along the arched path 2. For example, the star wheel 7 presents entrainment devices 8, which grip outward between the containers G. In this embodiment, the star wheel 7 can be a so-called pressure decreasing star wheel, which separates the containers, which in the feed conveyor 3 were standing against each other, from each other, so that they do not apply any pressure on each other and there are interstices which are advantageous for correct inspections. The effective external diameter of the star wheel 7 is smaller than the effective external diameter of the disk 1, so that a relatively wide arched path 2 is present, in which containers of different sizes and/or shapes can be inspected without noteworthy refitting work. Optionally, the containers G (indicated by a double arrow) are rotated about their axis during the transport along the arched path 2.

At least at the time of the transfer from the feed conveyor 3 to the disk 1, and the transfer from the disk 1 to the removal conveyor 4, the containers are also shifted relative to the disk 1.

Particularly when inspecting empty containers, especially bottles F, it has been shown that the resistance to wear of the materials described for the disk or their transparent area 10 allowing the passage of light through the container G, does not allow detectable wear, which could have a negative effect on the optical properties which are important to ensure consistent illumination. For this reason, it is even conceivable, in the embodiment of FIGS. 1 and 2, to arrange the disk 1 in a stationary manner, and to shift the containers G only by means of the rotating star 7 on the top side 9 of the disk 1. The star wheel 7, or its entrainment device 8, grips the containers G advantageously approximately at the height of the center of gravity of the container or at a lower place. If the disk 1 should be stationary, it would be sufficient to make only one circumferential section with the transparent material, for example, only the circumferential section of the disk which is associated with the inspection device A1.

The inspection machine M is characterized above all by a mechanically exceedingly simple transport system, which requires no, or no noteworthy, refitting work to reset to other container sizes and/or shapes. As a result, the inspection machine can be manufactured in a very cost advantageous manner. However, it can be advantageous not to use this concept for large output inspection machines, but to use it for conveyance outputs of, for example, at most 8000 containers/hours, where the inspected containers should advantageously be empty.

I/We claim:

1. Inspection machine (M) for checking containers (G), particularly bottles (F), comprising a conveyor (T) for transporting the containers (G) along an arched path (2) past at least one inspection device (A1-A4) which is associated at one of the height of and/or below the containers with the arched path, at least one illumination device (3) which is located below the arched path and shines light through the containers from below and upward, the conveyor (T) presenting a disk (1) which can be set in rotation, the top side (9) of the disk forming a standing surface for the bottom (15) of each container (G) to be transported, whereby the bottom of the container stands directly on the standing surface, and the disk being constructed so that it is transparent at least in some area (10).

2. Inspection machine according to claim 1, wherein the conveyor (T) presents, in addition to the disk (1), a star wheel (7) which can be set in rotation coaxially with respect to the disk (1) and which acts on the containers (G) above the top side (9) of the disk.

3. Inspection machine according to claim 2, wherein the star wheel (7) is designed as a pressure decreasing star.

4. Inspection machine according to claim 2, wherein the external diameter of the disk (1) is larger than the effective external diameter of the star wheel (7).

5. Inspection machine according to claim 17, wherein the feed conveyor (3) and a removal conveyor (4) are offset with respect to each other by approximately 180° with respect to the rotation axis (X) of the disk (1).

6. Inspection machine according to claim 1, wherein one of the disk (1), or the transparent area (10) of the disk (1) is made of one of glass or a plastic.

7. Inspection machine according to claim 1, wherein the conveyor (T) can be set in rotation one of continuously or intermittently.

8. Inspection machine according to claim 1, wherein an inspection device (A1) presents a bottom inspection device using illumination from below and at least one camera (16) placed above the upper container end.

9. Inspection machine according to claim 1, wherein an inspection device (A2, A4) is one of a device for inspecting the container's internal wall, or a device for inspecting the threading, or a device for detecting an alkaline solution, or a device for inspecting a mouth sealing surface, or a device for inspecting a carrier ring.

10. Inspection machine according to claim 1, wherein above the disk (1) at least one of one upper or one lateral illumination device is provided.

11. Inspection machine according to claim 1, and an external guide (6) for the containers (G) is provided at least along the arched path (2).

12. Inspection machine according to claim 1, wherein the containers (G) can be one of shifted by means of the conveyor (T) on the top side (9) of the disk (1) relative to the disk (1), and in a standing position, or they can be transported in a manner so they can be rotated.

13. Inspection machine according to claim 1, wherein the containers (G) can be transported with separation between them by means of the conveyor (T) at least along the arched path (2).

14. Inspection machine according to claim 5, wherein in the area of the removal conveyor (4), a station (A3) is provided for multiple wall inspections for the containers (G) which are separated from each other by the conveyor (T).

15. Inspection machine according to claim 5, and a controllable station (5) for sorting out is provided in the area of the removal conveyor (4).

16. Inspection machine according to claim 1, wherein a conveyance output of at most approximately 8000 containers/hour is provided.

17. Inspection machine according to claim 3, wherein the star wheel (7) works in cooperation with a feed conveyor (3) which delivers the container (G), standing against each other, into the inspection machine (M).

18. Inspection machine according to claim 6, wherein the plastic is polyethylene.

19. Inspection machine according to claim 9, wherein the device for inspecting the container's internal wall uses illumination from below.
